(19) United States
(12) Patent Application Publication
(10) Pub. No.: US 2010/0138677 A1
(43) Pub. Date: Jun. 3, 2010

(54) OPTIMIZATION OF DATA DISTRIBUTION AND POWER CONSUMPTION IN A DATA CENTER

(75) Inventors: William G. Pagan, Durham, NC (US); Moises Cases, Austin, TX (US); Paul A. Boothe, Austin, TX (US); Carl E. Jones, Tucson, AZ (US); Bhyrav M. Mutnury, Austin, TX (US)

Correspondence Address: STREETS & STEELE - IBM CORPORATION, 13100 WORTHAM CENTER DRIVE, SUITE 245, HOUSTON, TX, 77065, US

(73) Assignee: INTERNATIONAL BUSINESS MACHINES CORPORATION, Armonk, NY (US)

(21) Appl. No.: 12/325,314

(22) Filed: Dec. 1, 2008

(51) Int. Cl. G06F 1/32; G06F 12/02; G06F 13/00

(52) U.S. Cl. 713/320; 711/170; 711/E12.002; 711/E12.001

(57) ABSTRACT

The distribution of data among a plurality of data storage devices may be optimized, in one embodiment, by redistributing the data to move less-active data to lesser performing data storage devices and to move more-active data to higher performing data storage devices. Power consumption in the datacenter may be optimized by selectively reducing power to data storage devices to which less-active data, such as persistent data, has been moved.

### BACKGROUND OF THE INVENTION

1. Field of the Invention

The present invention relates to data storage and power management in datacenters.

2. Background of the Related Art

Increasingly large volumes of data are being stored in datacenters. So-called “persistent data” typically accounts for a substantial portion of data stored in a datacenter. Persistent data is infrequently accessed data, such as that used for regulatory compliance, archiving, disaster recovery, and referencing. For example, much persistent data has arisen due to government requirements to preserve data under the Sarbanes-Oxley Act (“SOX”). Inactive data is not unusable, but it is significantly less likely to be accessed than other data. It has been estimated that persistent data accounts for more than 70% of the data in some datacenters. It has also been estimated that about 37% of the power in a typical datacenter is consumed by data storage.

### BRIEF SUMMARY OF THE INVENTION

Embodiments of the invention include a method and software for monitoring the usage of data distributed among a plurality of data storage devices in a datacenter, and redistributing the data among the data storage devices to move less active data to less efficient data storage devices.

### BRIEF DESCRIPTION OF THE SEVERAL VIEWS OF THE DRAWINGS

FIG. 1 is a schematic diagram of a datacenter having a plurality of data storage devices for storing a large quantity of data.

FIG. 2 is a flowchart outlining a method for optimizing the storage of data in a datacenter according to an embodiment of the invention.

FIG. 2A is a flowchart illustrating the stepwise classification of data as persistent or non-persistent.

FIG. 2B is a flowchart outlining the stepwise redistribution of the data in step 48.

FIG. 3A is a schematic diagram showing an initial distribution of data files on data storage devices.

FIG. 3B is a schematic diagram of the data files of FIG. 3A sorted in order of increasing activity level.

FIG. 3C is a schematic diagram of the data storage devices sorted in order of increasing performance.

FIG. 3D is a schematic diagram of the data files having been redistributed to correlate the activity level of the data files with the efficiency of the data storage devices.

### DETAILED DESCRIPTION OF THE INVENTION

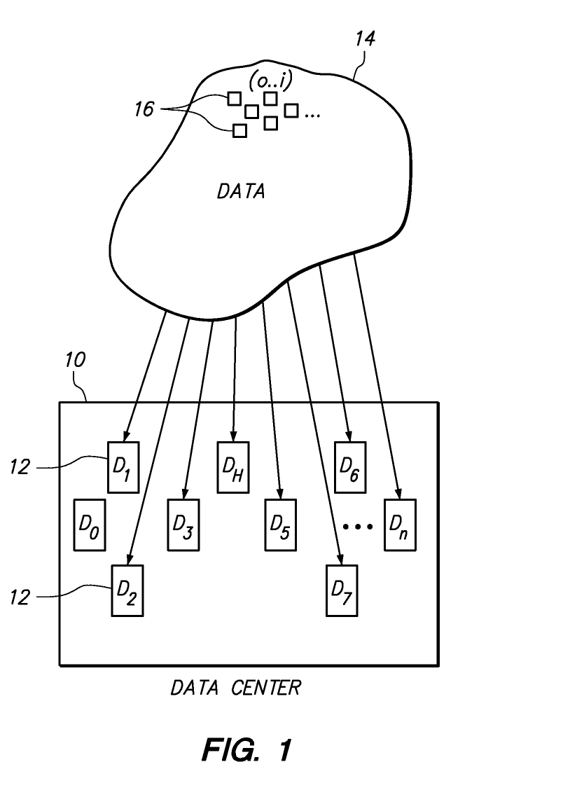

FIG. 1 is a schematic diagram of a datacenter 10 having a plurality of data storage devices 12 (D1 . . . Dn) for storing a large quantity of data 14. The data storage devices 12 in the datacenter 10 may include conventional hard drives with rotating magnetic disks, solid state hard drives, RAID systems, other data storage devices or systems now known or developed in the future. The data storage devices may reside on servers (not shown), which typically include other electronic components, such as processors for processing the data 14 and short-term memory, such as dual in-line memory modules (DIMMs), for temporarily storing a portion of the data 14 as it is accessed. The data storage devices 12 may also include dedicated data storage devices separate from any servers, such as external hard drives. The data 14 is electronically stored in a digital format on the data storage devices 12. The data storage devices 12 in the datacenter 10 may, in some instances, have the collective capacity to store a very large volume of data, such as on the order of many terabytes of data.

The data 14 is structured in the form of electronic data files 16 (0 . . . i) stored on the data storage devices 12 in a digital format. The electronic data files 16 will typically vary in size. For example, images of paper documents to be stored on the data storage devices 12 may be embodied in any of a variety of data file formats, such as JPEGs or PDF data file formats, and will typically vary in size anywhere between several kilobytes (KB) and many megabytes (MB). Other types of data files, such as videos, data file formats or databases, may have even larger data file sizes. Also, some types of data may be structured as related data files. For example, individual tables of a database may be stored as separate but related data files. Groups of related data files may be stored in proximity, such as generally on the same server or, more specifically, within the same sector or group of sectors of a hard drive. However, memory storage and retrieval techniques known in the computer industry may allow related portions of the data 14 to reside at different locations on a data storage device 12 or on more than one data storage device 12, in which case the related data files may be electronically mapped to the different physical locations in the datacenter 10.

Performance of the various data storage devices 12 in the datacenter 10 may vary substantially. The performance of commercially available data storage devices has continually improved with advances in technology. For example, the read/write speed of conventional hard drives with rotating magnetic disks has increased over time, and solid-state hard drives have been introduced having superior speed and efficiency to most magnetic-disk hard drives. Data storage devices such as magnetic-disk hard drives and solid-state hard drives remain usable despite ongoing technological advances, and so data storage devices generally remain in service for a period of time, despite the continual introduction of better-performing devices to the market. Thus, a multitude of data storage devices operating at different performance levels are likely to be present in the datacenter 10.

The activity level of the data 14 stored on the data storage devices 12 may also vary substantially. The activity level describes the usage characteristics of the various data files. For example, human resource data for a corporation may be routinely accessed for administration of payroll and benefits. By comparison, other types of data, such as Sarbanes-Oxley compliance data, may be stored long-term to satisfy government regulatory requirements, but without any immediate or ongoing need to be accessed. The activity level of the various data 14 may be characterized in terms of the frequency at which the data files 16 are accessed. For example, the activity level of a particular data file 16 may be characterized by the access frequency of that file, and the activity level of a group of related data files 16 may be characterized by the access frequency of any of the data files in that group. For example, in the context of a database application, individual tables may be stored in separate data files, and the activity level may be determined for individual tables or for a group of related data files within the database. The relative activity level of different data files 16 may be established by comparison of the activity levels. The activity level may be expressed numerically and used internally to compare activity levels, without being expressly communicated to a user. As data is added to the datacenter 10, the data 14 may initially be located on any of the various data storage devices 12 without knowledge of the activity level of the data 14. Immediately following this initial storage of the data, there may be little or no correlation between the activity level of the data 14 and the performance of the data storage devices 12.

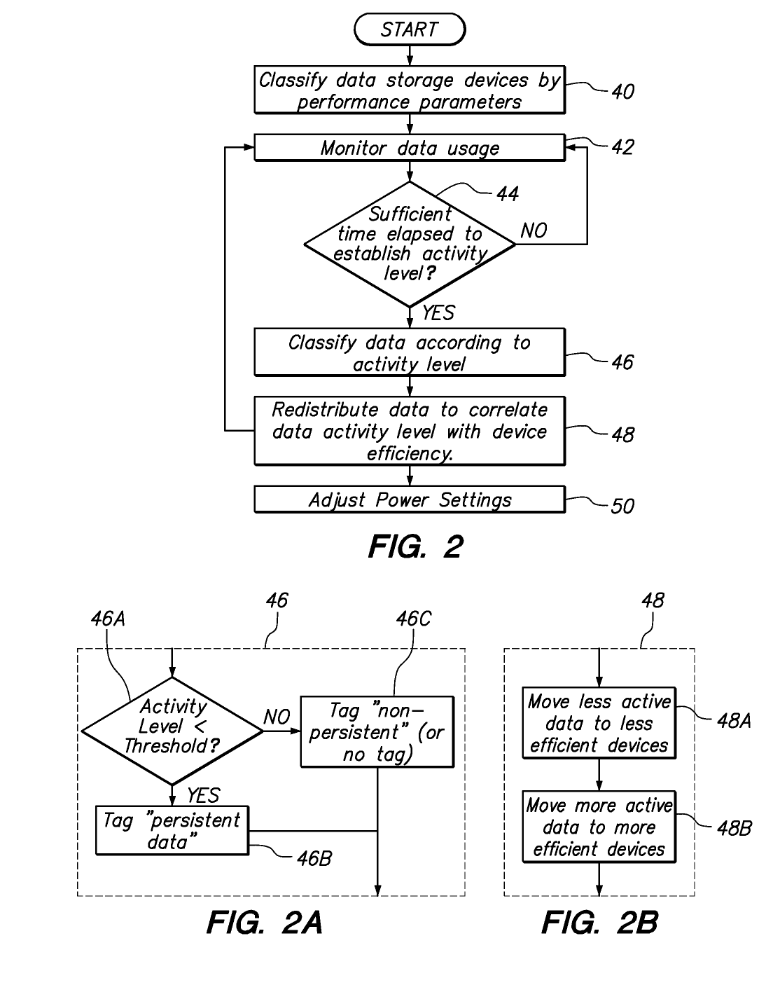

FIG. 2 is a flowchart outlining a method for optimizing the storage of data in a datacenter according to an embodiment of the invention. The method may be used to optimize the storage of the data 14 in the datacenter 10 of FIG. 1, for example. The following description summarizes the steps of the flowchart. Further details regarding the manner in which the individual steps may be implemented may be informed by reference to the preceding description and figures. In step 40, a plurality of data storage devices are classified by one or more performance parameters, such as speed and/or energy efficiency. The classification of the data storage devices may include establishing a hierarchy or ranking, with the best performing (e.g. fastest or most energy efficient) data storage devices at the top of the ranking. The devices may be grouped into different classes or subclasses, with a different range of performance parameters in each class or subclass. For example, a group of solid-state drives may be designated as one class and a group of magnetic-disk hard drives may be designated as another class. Devices or groups of devices may be further grouped within subclasses defined by a narrower or more specific range of speeds or energy efficiencies. The devices may also be individually ranked by performance parameters. For example, the data storage devices may be individually ranked according to their relative performance among the data storage devices.

Data usage is monitored in step 42 in order to determine an activity level associated with the data. Initially, the data may be randomly distributed among the various data storage devices, or distributed among the data storage devices without any purposeful correlation between the activity level of the data or the performance of the various data storage devices. The relative activity level of the various data will become more prominent over time as usage characteristics can be progressively ascertained. For example, the activity level of data that is accessed less than once per week may require several weeks of monitoring to become apparent, whereas the activity level of data accessed several times per day may be apparent in a shorter timeframe. Thus, the data usage is monitored according to step 42 until sufficient time has elapsed to distinctly establish a relative activity level of the stored data.

The method may include a predetermined or user-selectable granularity at which the data activity level is determined. The granularity is the scope, range or size of a data file or other data unit that is identified as having its own activity level. More specifically, the activity level of the data may be, for example, determined for each file of data, each directory of data, each file type, or each group of files designated as related files, such as related tables of a database.

Step 46 involves the classification of data by activity level. The classification of the data by activity level may include grouping data files into different activity level ranges, such as different ranges of access frequency. The classification of the data by activity level may also include individually ranking the data on a per-file basis. The activity level may be characterized by access frequency, wherein “access” may include a read operation, a write operation, or both. FIG. 2A is a flowchart illustrating the stepwise classification of data into a first group of persistent data and a second group of non-persistent in step 46. Conditional step 46A compares the activity level of a data file or other data unit to a predefined threshold. All data having an activity level less than the predefined threshold may be classified as “persistent data” according to step 46B. The remaining data, having an activity level equal to or greater than the predefined threshold, may be classified as non-persistent according to step 46C. The value of the predefined threshold is situation-dependent and may be selected in advance based on empirical data. For example, the activity level for a sample of the type of data generally considered in the industry to be persistent data may be selected, and an upper limit on that activity level may be selected as the predefined threshold.

In step 48, the data is redistributed among the data storage devices to correlate data activity level (determined in step 46) with device efficiency (determined in step 40). Step 48 allows the data to be redistributed to better match the activity level of the data with the performance of the data storage devices, so that more active data are stored on better performing (e.g. faster or more efficient) data storage devices. FIG. 2B is a flowchart outlining the stepwise redistribution of the data in step 48. Less active data is generally moved to less efficient data storage devices in step 48A. In turn, storage space may be liberated on the less efficient data storage devices by moving data with a higher activity level to better performing data storage devices according to step 48B. If the data has generally been classified as either persistent or non-persistent, the persistent data may be consolidated on a subset of the least-efficient data storage devices having sufficient capacity to store the persistent data. The non-persistent data may then be redistributed among the remaining data storage devices. The data may be re-distributed so that the net activity level of the data on each data storage devices increases with increasing device efficiency. The data may be moved between data storage devices by reading the data from a first storage device, copying the data to a second storage device, and erasing or marking the data for deletion from the first storage device.

It should be noted that data storage devices may have different power efficiencies when they are driven at different utilizations. Accordingly, the performance parameters (e.g. efficiency) of a device may change in response to a change in the net activity level of the data stored on the device. Thus, the assessment of device performance in step 40 may depend, to some degree, on a prospective re-distribution of data. The assessment of device performance may, therefore, be performed in tandem, or iteratively, with the step of selecting a re-distribution profile of the data, to ensure that the desired correlation between activity level and performance is achieved upon re-distribution of the data.

A more efficient power consumption profile may be obtained in the datacenter, by allocating more power to the data storage devices on which more active data is stored and reducing power to the data storage devices on which less-active data is stored. In step 50, power settings of the data storage devices are optimized according to the redistributed data that is now stored on that device. The power settings to the various data storage devices are adjusted to better correlate with the activity level of the data on the data storage devices. Power may be reduced to less efficient devices, on which relatively inactive data is stored following the redistribution of data in step 48. The amount of power consumed by data storage can be managed by a disk drive controller or device driver executing in the host operating system, which adjust the power usage to an active, standby, idle or sleep mode based on the frequency of user access. Lower power consumption modes, such as standby, idle or sleep, conserves power at the expense of increasing disk latency. The lower the power consumption mode, the greater the latency and delays that occur to fully power-up the disk drive to execute an input/output request. According to at least one embodiment, the data storage devices on which the persistent data is stored may be placed at the lowest power state or even powered off. Reducing power to certain data storage devices may liberate power allocated to the datacenter to be used on the more efficient data storage devices on which the more active data is now stored.

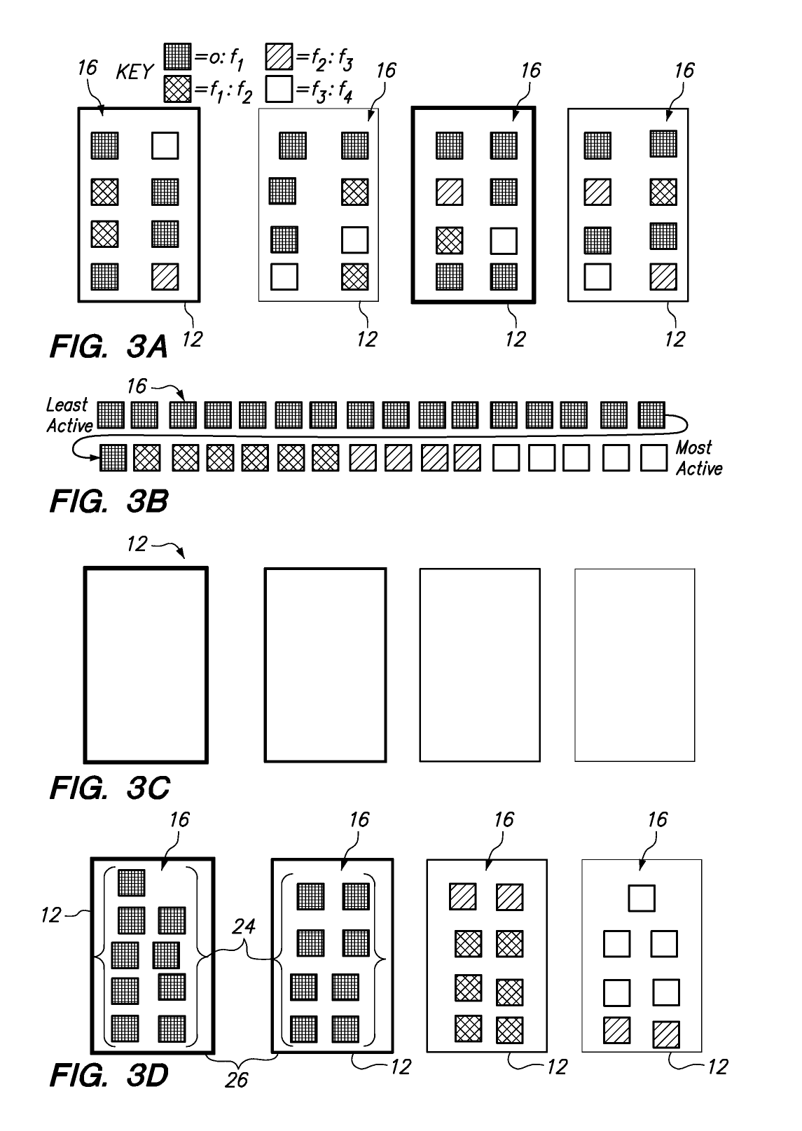

FIGS. 3A-3D are a series of diagrams that schematically illustrate an exemplary redistribution of the data files 16 on four data storage devices 12 according to the activity level of the data files 16. FIG. 3A shows how the data files 16 may be initially distributed on the data storage devices 12. For simplicity, the number of data files 16 are evenly distributed on the four data storage devices 12, although the individual data storage devices 12 may have the capacity to store additional data files. The activity level is characterized by access frequency, with the data files 16 being classified into four access frequency ranges: a first frequency range of between 0 and f1, a second frequency range of between f1 and f2, a third frequency range of between f2 and f3, and a fourth frequency range of between f3 and f4. Each frequency range is represented by a different shading pattern as indicated in the KEY. The performance level of the data storage devices 16 is characterized by efficiency, as indicated by the line weight, with thicker line weight representing a slower or less efficient data storage device 12, and a thinner line weight represents a faster or more efficient data storage device 12. As is evident in FIG. 3A, the data files 16 are initially distributed on the data storage devices 12 with no correlation between activity level and performance. Thus, each data storage device 12 has an essentially random assortment of data files 16 in different frequency ranges.

FIG. 3B is a schematic diagram of the data files 16 sorted in order of increasing activity level (the “activity level spectrum”). The subset of the data files 16 in the first frequency range (0:f1) are at the beginning of the activity level spectrum, followed by the subset of the data files 16 in the second data class (f1:f2), the subset of the data files 16 in the third data class (f2:f3), and the subset of the data files 16 in the fourth data class (f3:f4). Although not shown, the data files 16 within a particular frequency range may also be ranked within that frequency range. For example, the seventeen data files in the first frequency range (0:f1) may be sorted in order of increasing frequency within the first frequency range, such that the first data file in the activity level spectrum has the lowest activity level and the seventeenth data file has the highest activity level.

FIG. 3C is a schematic diagram of the data storage devices 12 sorted in order of increasing performance as measured in this example by efficiency (the “device performance spectrum”). Thus, the first data storage device 12 in the device performance spectrum is the least efficient) data storage device 12, and the last data storage device 12 in the device performance spectrum is the most efficient data storage device 12.

FIG. 3D is a schematic diagram of the data files 16 having been redistributed to correlate the activity level (in this case, access frequency) of the data files 16 with the efficiency of the data storage devices 12. The data files 16 may be electronically moved between the data storage devices 12 using a computer-executable sort subroutine that results in moving less active data to less efficient data storage devices and moving more active data to more efficient data storage devices. The data is now redistributed so that the net activity level for each data storage device 12 increases with increasing efficiency of the data storage devices 12. A least active subset 24 of the data files 16, which are in the first frequency range (0:f1), have been consolidated on a least efficient subset 26 of the two data storage devices 12. The remainder of the data files 16, from the higher access-frequency ranges, are stored on the remaining two of the data storage devices 12. The least efficient subset 26 of the data storage devices 12 in this example now contain only data files 16 in the first frequency range (0:f1), while the more efficient two of the data storage devices 12 contain an assortment of data files 16 from the other three frequency ranges. Isolating the least active subset 24 of the data files 16 from the remainder of the data files 16 in this manner may be desirable so that power setting may be uniquely applied to the subset 26 of the data storage devices 12 to which the least active subset 24 of the data files 16 have been redistributed. For example, the least active subset 24 of the data files 16 may be persistent data, and the subset 26 of the data storage devices 12 on which the persistent data is stored may be given power settings that would not ordinarily be desirable for the remainder of the data storage devices 12 on which non-persistent data are now stored.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A data-management method, comprising:
monitoring the usage of data distributed among a plurality of data storage devices in a datacenter; and
redistributing the data among the data storage devices to move less active data to less efficient data storage devices.

2. The data-management method of claim 1, further comprising:
redistributing the data such that the net activity level of the data on each data storage device increases with increasing efficiency of the data storage devices.

3. The data-management method of claim 1, further comprising:
adjusting power to the data storage devices according to the activity level of the redistributed data on the data storage devices.

4. The data-management method of claim 1, further comprising:
identifying, as persistent data, a subset of the data having an activity level of less than a threshold value;
identifying the least efficient subset of the data storage devices having sufficient storage capacity to store the persistent data; and
consolidating the persistent data on the identified subset of the data storage devices.

5. The data-management method of claim 4, further comprising:
reducing power to the data storage devices on which the persistent data has been consolidated.

6. The data-management method of claim 5, wherein the step of reducing power to the identified subset of the data storage devices includes invoking an idle mode, sleep mode, or hibernation mode, powering off the subset of the data storage devices, or powering off one or more magnetic disks on the data storage devices on which the persistent data has been consolidated.

7. The data-management method of claim 1, further comprising:
classifying or ranking the data according to activity level.

8. The data-management method of claim 7, wherein the step of classifying or ranking the data according to activity level comprises classifying or ranking the data according to the frequency at which the data is accessed.

9. The data-management method of claim 7, wherein the step of classifying or ranking the data according to activity level comprises classifying or ranking the data by the date of most recent access.

10. The data-management method of claim 1, further comprising:
determining the activity level of the data by electronically scanning the data storage devices and electronically tagging data files according to activity level.

11. A computer program product including computer usable program code embodied on a computer usable medium for optimizing the distribution of data in a datacenter, the computer program product including:
computer usable program code for monitoring the usage of data distributed among a plurality of data storage devices in a datacenter; and
computer usable program code for redistributing the data among the data storage devices to move less active data to less efficient data storage devices.

12. The computer program product of claim 11, further comprising:
computer usable program code for redistributing the data such that the net activity level of the data on each data storage device increases with increasing efficiency of the data storage devices.

13. The computer program product of claim 11, further comprising:
computer usable program code for adjusting power to the data storage devices according to the activity level of the redistributed data on the data storage devices.

14. The computer program product of claim 11, further comprising:
computer usable program code for identifying, as persistent data, a subset of the data having an activity level of less than a threshold value;
computer usable program code for identifying the least efficient subset of the data storage devices having sufficient storage capacity to store the persistent data; and
computer usable program code for consolidating the persistent data on the identified subset of the data storage devices.

15. The computer program product of claim 14, further comprising:
computer usable program code for reducing power to the data storage devices on which the persistent data has been consolidated.

16. The computer program product of claim 15, wherein the computer usable program code for reducing power to the identified subset of the data storage devices includes computer usable program code for invoking an idle mode, sleep mode, or hibernation mode, powering off the subset of the data storage devices, or powering off one or more magnetic disks on the data storage devices on which the persistent data has been consolidated.

17. The computer program product of claim 11, further comprising:
computer usable program code for classifying or ranking the data according to activity level.

18. The computer program product of claim 17, further comprising:
computer usable program code for classifying or ranking the data according to the frequency at which the data is accessed.

19. The computer program product of claim 17, further comprising:
computer usable program code for classifying or ranking the data by the date of most recent access.

20. The computer program product of claim 11, further comprising:
computer usable program code for determining the activity level of the data by electronically scanning the data storage devices and electronically tagging data files according to activity level.
